(19) United States
(12) Patent Application Publication
(10) Pub. No.: US 2026/0119536 A1
(43) Pub. Date: Apr. 30, 2026

(54) DATA CONTROL AND CUSTOMIZED REPORT GENERATION SYSTEM LEVERAGING LLM CAPABILITIES

(71) Applicant: SAP SE, Walldorf (DE)

(72) Inventors: Nisheeth AGARWAL, Bangalore (IN); Merbin J. ANSELM, Tirunelveli (IN); Shreyas PARTHASARATHY, Bangalore (IN); Lav KHERWA, Bhopal (IN)

(21) Appl. No.: 18/925,194

(22) Filed: Oct. 24, 2024

(51) Int. Cl. G06F 16/332; G06F 16/33; G06F 40/186

(52) U.S. Cl. CPC G06F 16/3329; G06F 16/3347; G06F 40/186

(57) ABSTRACT

System, method, and various embodiments for a functional code generation system leveraging LLM capabilities, are described herein. An embodiment operates by receiving a user instruction to generate a report. An information prompt is generated, and an large language model (LLM) derives a plurality of vectors from the instruction, including a first vector. A first question is identified based on comparing the first vector to a plurality of questions; the first question is associated with a first query template. A query result from a collection database based on executing a query corresponding to the first query template against the collection database. The LLM is instructed to generate an answer comprising a natural language interpretation of the query result in view of the first question. The LLM is instructed to generate a report based on the answer in view of the user instruction.

### BACKGROUND

With the growth of artificial intelligence, particularly with regard to large language models (LLMs), users are able to create content through the LLM. However, without proper constraints, the LLM may generate content including authoritative statements that are based on unreliable or irrelevant data, thus corrupting the content created by the LLM. Further, the user may be unaware of the unreliability of the data sources relied upon by the LLM, thus causing the user to make poor decisions based on the consequently unreliable content generated by the LLM.

### BRIEF DESCRIPTION OF THE DRAWINGS

The accompanying drawings are incorporated herein and form a part of the specification.

FIG. 1 is a block diagram illustrating an example data control and reporting system (DRS), according to some embodiments.

FIG. 2 illustrates example intermediary output which may be generated by a data control and reporting system (DRS), according to some embodiments.

FIG. 3 is a flowchart illustrating example operations for providing a data control and reporting system (DRS), according to some embodiments.

FIGS. 4A and 4B illustrate example operations for generating different content by a data control and reporting system (DRS), according to some embodiments.

FIG. 5 is example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for providing a data control and customized report generation system leveraging large language model (LLM) capabilities.

With the growth of artificial intelligence, particularly with regard to large language models (LLMs), users are able to create content through the LLM. However, without proper constraints, the LLM may generate content including authoritative statements that are based on unreliable or irrelevant data, thus corrupting the content created by the LLM. Further, the user may be unaware of the unreliability of the data sources relied upon by the LLM, thus causing the user to make poor decisions based on the consequently unreliable content generated by the LLM.

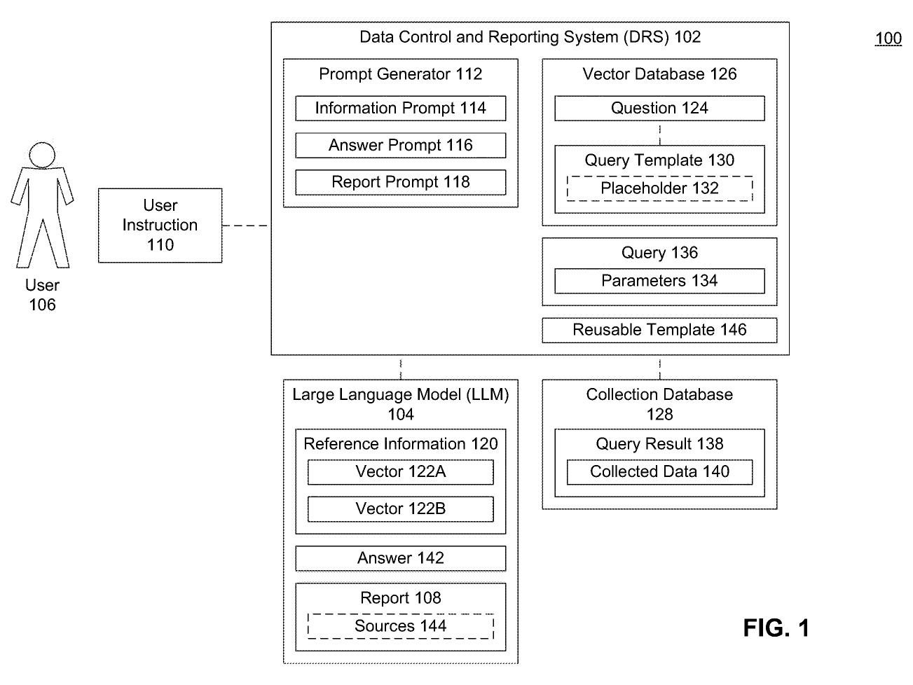

FIG. 1 is a block diagram 100 illustrating an example data control and reporting system (DRS) 102, according to some embodiments. DRS 102 may leverage the processing capabilities of a large language model (LLM) 104 to allow a user 106 to generate or request the generation of content in the form of one or more reports 108.

However one of the challenges in using an LLM to create content is that the LLM can rely on any data to generate the content. And not all data is created equal, not all data sources are reliable, and some data is irrelevant to the actual content the user desires, but nonetheless may be relied upon by the LLM if there are not data constraints in place. The functionality described below with regards to DRS 102 addresses these and other challenges with regard to creating content using an LLM.

Rather than simply requesting an LLM to generate content, which may allow the LLM to use a wide range of data sources, including unreliable, irrelevant, and even incorrect data sources, DRS 102 manages and controls, and even limits, the data that the LLM 104 is allowed to use in generating the report 108 or other content. DRS 102 causes both faster report generation by limiting the amount of data accessible to the LLM 104 in generating the report 108, and improved quality of the content created by the LLM 104 because the report(s) 108 are generated based pre-identified, verified, known, or otherwise reliable or trusted data that is relevant to a user inquiry or user instruction 110.

In some embodiments, user 106 may submit a user instruction 110 to DRS 102. The user 106 may use their computer, phone, or other computing device to submit a natural language user instruction 110 requesting LLM 104 to generate specified content in to form of a report 108. For example, user instruction 110 may be “Give me a report comparing the greenhouse emissions of factory A, factory B, and factory C for the year 2023.” The report 108 may include any content that is generated in response to a user inquiry, and may take the form of a chart, table, graph, text, or other media, or a sectioned document including any combination of text, charts, tables, graphs, images, or other media.

Upon receiving the user instruction 110, a prompt generator 112 may generate one or more guidelines or commands for LLM 104 to perform some functionality involved in generating a response (e.g., report 108) to the instruction 110, referred to as a prompt. A prompt may include one or more lines of text organized across one or more documents that is particularly formatted to by understandable by a large language model (LLM) 104. LLM 104 may include an artificial intelligence, machine learning, or deep learning model that is configured to execute data processing commands from plain-text (e.g., not requiring computer language or coded input). LLM 104 may include any computing system that is configured to perform processing tasks based on text-based or plain language inputs. LLM 104 may be configured to create original content from one or more documents or input in accordance with a prompt. In some embodiments, LLM 104 may include a generative pre-training transformer (GPT).

Example prompts which may be generated by prompt generator 112 include an information prompt 114, answer prompt 116, and report prompt 118. In other embodiments, different or additional prompts may be generated.

Information prompt 114 may request LLM 104 to identify what data or information is necessary to address the user instruction 110 and generate a report 108. Leveraging the natural language processing capabilities of LLM 104, information prompt 114 may request reference information 120 from LLM 104 indicating which data would be helpful or necessary in generating the response or report 108 to user instruction 110. The reference information 120 may take the form one or more vectors 122A, 122B (referred to herein generally as vector 122 or vectors 122).

Vector 122 may include a portion of information necessary to generate a response to the user instruction 110, in the form of a report 108. In some embodiments, the vector 122 may include one or more keywords or statements describing the type of information or data which may be useful to fulfilling the request from the user 106 as provided in user instruction 110. LLM 104 may be trained to perform initial NLP (natural language processing) on the user instructions 110 provided by user 106 generate one or more vectors 122. Reference information 120 include a collection of the one or more vectors 122 generated by LLM 104 in response to information prompt 114. The reference information 120 may be returned to DRS 102.

While in some embodiments, the user 106 may provide all the required information before DRS 102 performs the processing described herein. In other embodiments, the user 106 may fail to provide certain information, which may be later requested by DRS 102. In some embodiments, the reference information 120 may include a response indicating that additional information is needed from the user 106 (e.g., that user instruction 110 is missing some information). For example, if user instruction 110 indicates “Generate a report for greenhouse emissions for factory A and factory B”. LLM 104 may identify that the timeframe is missing. As such, DRS 102 may prompt the user 106 to enter a desired timeframe, or enter “all” for all timeframes available. The user 110 may provide an entry such as “Oct 2022-Dec 2023.” This subsequent information provided by the user 106 may then be included in a new information prompt 114 including both the initial user instruction 110 and the subsequent data provided by the user 106.

An example of the reference information 120 which may be generated by LLM 104 may include vector 122A “greenhouse emission information for factory A for Oct 2022-Dec 2023” and vector 122B “greenhouse emission information for factory B for Oct 2022-Dec 2023”. In some embodiments, LLM 104 may identify and including in the reference information 120 a format for the report 108 (e.g., text, chart, graph, table, etc.) as may be specified in user instruction 110.

After the vectors 122 have been generated, the actual data indicated by the vectors 122 needs to be extracted from a collection database 128 where data to be relied upon in generating a response or report 108 to the user instruction 110 may be stored. However, a vector 122 cannot be directed executed against a database. DRS 102 needs to generate a query 136 to be executed against the collection database 128 that extracts the information as specified in the vectors 122. The query generation may begin with a particular vector 122 as created or generated by LLM 104.

In some embodiments, DRS 102 may use a vector 122 (as generated by LLM 104) to identify one or more questions 124 from a vector database 126 related to the vector 122 (and may do this for each vector 122). Vector database 126 may include a library, database, or other storage of a plurality of questions 124 which may be searched based on vectors 122. For simplicity only a single question 124 is illustrated, however it is understood that vector database 126 may be a questions bank that includes any number of questions 124 capturing exhaustive dimensions of the data available in the source system which may be required by any report for relevance.

Each question 124 may include a pre-written question that is designed to extract a set of information or data from a collection database 128. Each question 124 may be a natural language statement that is directed to extracting particular information. In some embodiments, DRS 102 may compare the vectors 122 to the questions 124 to identify the most relevant question(s) 124 to each vector 122.

In some embodiments, in identifying the relevant question(s) 124 for each vector 122, DRS 102 may perform the similarity search using Euclidean distance, Cosine distance, Manhattan distance, Jaccard distance, or Mahalanobis distance to compare the similarity between vector 122 and a given entry corresponding to a question 124 in vector database 126. In some embodiments, the similarity search between a vector 122 and vector database 126 may return zero, one, or multiple questions 124 which are determined as being relevant to the vector 122.

In some embodiments, DRS 102 may provide an intermediate output or inquiry to user 106 for user approval before performing additional processing. This intermediate output may include outputting to the user 106 the user instruction 110, the generated vector(s) 122, and the identified question(s) 124. The user 106 may be prompted to confirm whether the questions 124 seem relevant to the user’s instruction 110. Or, for example, if multiple questions 124 are identified for a particular vector 122, to narrow the search and provide a response that is directed to what the user 106 intended, the user 106 may be prompted to identify the question 124 that is most relevant to the intended inquiry by the user 106. DRS 102 may then use the question 124 is selected by the user 106 (or questions 124 if more than one question 124 is selected by the user 106) to continue processing.

In some embodiments, if the user 106 is not satisfied with the question(s) 124, the user 106 may be able to provide a new instruction 110 which may restart the process, causing LLM 104 to generate one or more new vectors 122.

This intermediate verification step may allow the user 106 to control what question(s) 124 or data is being used to generate the report 108, thus improving the quality of any generated report 108 or other content. This also helps minimize using the additional computing resources that would be necessary in repeated report generation which may be necessary if the output (e.g., report 108) was not what the user desired or intended. In some embodiments, the user 106 may elect to skip this intermediate verification process.

In some embodiments, each question 124 may have its own query template 130. The query template 130 may include a structured query language (SQL) version of the question 124 that is to be executed against collection database 128. For simplicity, only a single query template 130 is illustrated, but it is understood that each question 124 may include, correspond to, or otherwise point to its own query template 130. In some embodiments, the query templates 130 may be stored in a separate data structure and vector database 126 may include an identifier or pointer to the corresponding query template 130 for each question 124. In some embodiments, vector database 126 may include key value pairs, in which the question 124 is the key and query template 130 is the paired value.

In some embodiments, a query template 130 may include one or more placeholders 132. A placeholder 132 may include a portion of the template where specific information relevant to the user instruction 110 is to be filled in to perform the search for relevant data in the collection database. An example question 124 may be directed to retrieving emissions data for [factory] over [time period], where [factory] and [time period] may correspond to the placeholders 132 in an SQL query template 130 which was pre-generated for the question 124.

Each placeholder 132 may be filled in or replaced with a parameter 134. The parameter 134 may be the specific information requested by the user 106 through user instruction 110, which may have been identified by LLM 104, and included in a corresponding vector 122. In some embodiments, the parameters 134 (e.g., information used to fill in or replace the placeholders 132) may be received directly from the user 106 through providing a series of one or more guided prompts, which prompt the user 106 to enter the parameter information 134.

In continuing the example above, the parameters 134 may include both the specific factory [factory Q, factory X] and time period [2000-2012] information as determined from user instruction 110 or new user inputs (e.g., in response to guided prompts), and included in a vector 122. These parameters 134 may be used to replace the corresponding placeholders 132 to generate a query 136. For simplicity, a single parameter 134 is illustrated, however it is understood that query 136 may include multiple parameters 134. Using the query template 130 is advantageous in that it both reduces additional computing processing that would otherwise be required to generate a query from scratch, and may have been pre-tested or configured to extract precise information as related to the question 124. Furthermore, SQL commands generated by an LLM 104 tend to be unreliable and produce unpredictable results.

Query 136 may include an SQL query or other computing language command which may be executed against collection database 128 to generate a query result 138. In some embodiments, the query 136 may include the query template 130 in which the placeholders 132 are replaced with parameters 134. In some embodiments, the query 136 (with parameters 134) may be executable against collection database 128, while the query template 130 is not executable on account of placeholders 132. For simplicity, a single query 136 is illustrated, however it is understood that there may be multiple queries 136.

In some embodiments, DRS 102 may execute or provide a query 136 to be executed against collection database 128. The result of the query 136 may be a query result 138 including collected data 140. In some embodiments, the query result 138 may include collected data 140 over multiple queries 136. For example, a single vector 122 may correspond to multiple questions 124, each question 124 corresponding to its own query template 130 from which a query 136 is generated and executed. The query results 138 may then include the collected data 140 across the various queries 136 corresponding to the same vector 122, or across multiple vectors 122 (e.g., each of which is associated with the same user instruction 110). In some embodiments, collection database 128 may return multiple query results 138 back to DRS 102.

In some embodiments, prompt generator 112 may generate an answer prompt 116. The answer prompt 116 may include instructions for LLM 104 to generate one or more answers 142 (for simplicity, a single answer 142 is illustrated). The answer prompt 116 may include the identified question(s) 124 corresponding to a particular vector 122, and the query result 138 including the collected data 140 returned as a result of executing a corresponding query 136 against collection database 128, commanding LLM 104 to generate an answer 142.

The answer 142 may include some combination of a question 124 and a natural language response based on the corresponding collected data 140 across one or more query results 138. In some embodiments, in preparing answer 142, LLM 104 may select a subset of the collected data 140 across one or more query results 138 to rely upon in generating answer 142, and thus may not rely upon all the collected data 140 in a query result 138.

In some embodiments, the answer prompt 116 may specify a format for the answer 142. Example answer formats may include a chart, graph, table, text, or combination thereof. In some embodiments, LLM 104 may choose the answer format that is most applicable to the answer 142.

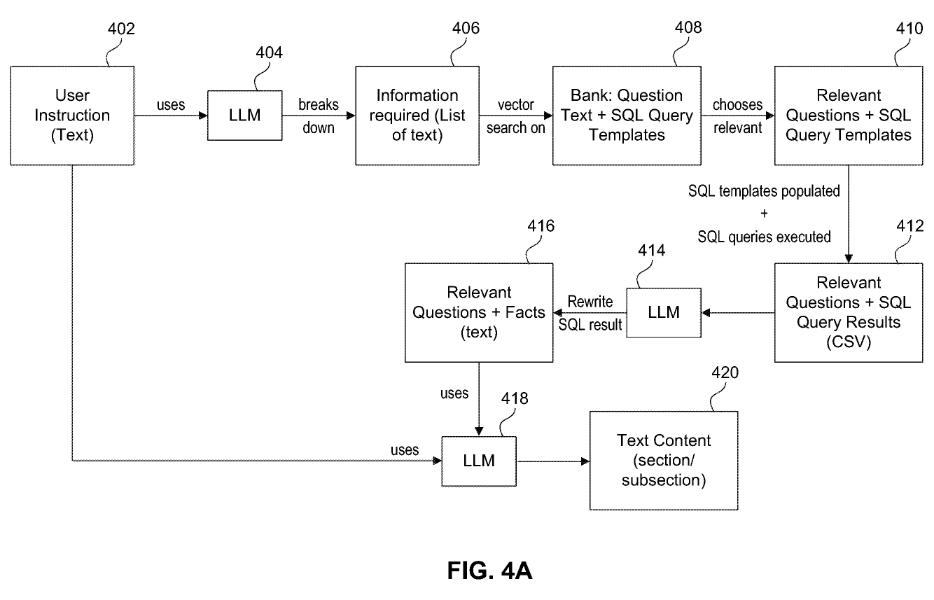

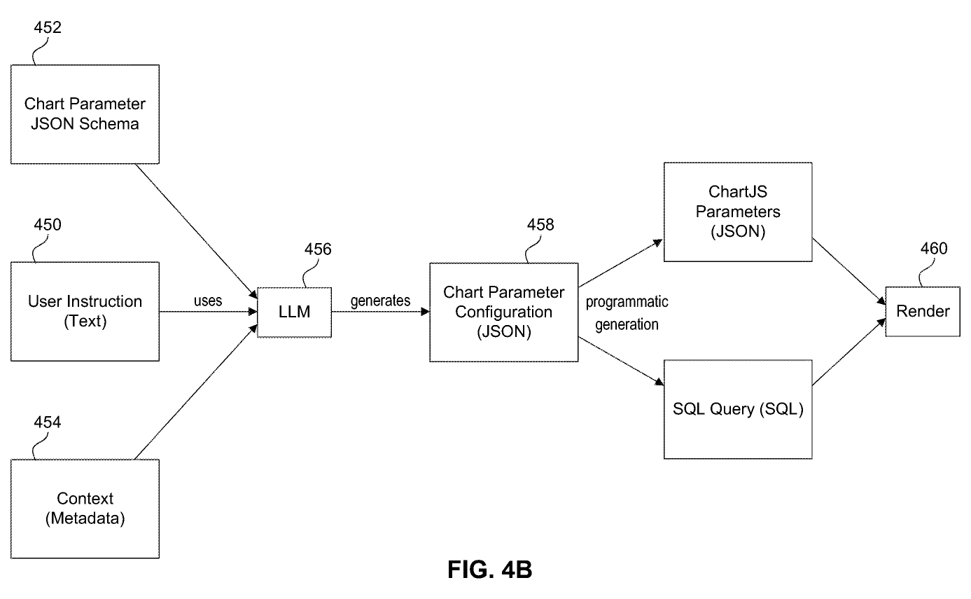

In some embodiments, the user instruction 110 may specify an answer format. For example, the user instruction 110 may specify a chart illustrating financial spending over the eight previous quarters. As such, the answer 142 may be a chart, as specified in the user instruction 110. In some embodiments, the creation of a report 108 may include similar processes no matter the form of the output (e.g., text, chart, table, etc). However, in some embodiments, the processes performed by DRS 102 may vary depending on whether the output or report 108 is text relative to whether the output or report 108 is a chart or table. These differences between generating textual content and chart/table content are described in greater detail below with regard to FIGS. 4A and 4B, in accordance with some example embodiments.

In some embodiments, DRS 102 may perform a second intermediary check or verification check with user 106 after the generation of one or more answers 142. For example, the second verification check may provide the questions 124 and corresponding answers 142 to the user 106 for review prior to generating a final report 108. In some embodiments, the second verification check may be performed in addition to or in lieu of the previously referenced intermediary check. This may give the user 106 the opportunity to review and verify the answers 142 are correct before generating the final report 108. If a user 106 indicates a particular answer 142 is not correct, the report 108 may be generated without that answer 142, or the user 106 may be provided the option to provide a new user instruction 110 and restart the process. In some embodiments, the user 106 may elect to skip the verification check.

In some embodiments, prompt generator 112 may generate a report prompt 118. The report prompt 118 may include the answer(s) 142 generated by LLM 104 and the original user instruction 110 as input, and request a report 108 as output. The report 108 may include a comprehensive response to the user instruction 110, including the answer(s) 142, arranged into a cohesive document, which may include one or more sections (e.g., each section may correspond to a different answer 142).

In some embodiments, the report 108 may include a sources 144 section. The sources 144 may include a breakdown the intermediary output and/or THE verification check output as referenced above. For example, the sources 144 section may include the original user instruction 110, the generated vectors 122, the identified questions 124, the corresponding queries 136, and the generated answers 142. The sources 144 may include a separate document or file, that the user 106 may review to understand how the report 108 was generated and what data was queried and relied upon and what intermediary conclusions were drawn from that data (e.g., collected data 140). The sources 144 may provide the user 106 the opportunity to verify that each building block of the report 108 was correct, which may provide confidence in making any decisions based on the report 108. If the user 106 identifies something they do not like in the sources 144, they may be able to generate a new report 108 with a new instruction 110 correcting for the previous mistake or error they identified in the sources 144.

In some embodiments, DRS 102 may generate a reusable template 146. The reusable template 146 may include the original instruction 110, the generated vectors 122, and identified questions 124 and query templates 130. This reusable template 146 may reduce reliance upon the LLM 104 if the same instruction 110 wants to be used again by the user 106 (or a different user 106) at a later date/time. This minimization of the back-and-forth and processing between DRS 102 and LLM 104 save both time and processing resources in generating a new report 108. In some embodiments, the queries 136 may be executed against collection database 128 in case any of the data has changed from when the reusable template 146 was initially or previously executed.

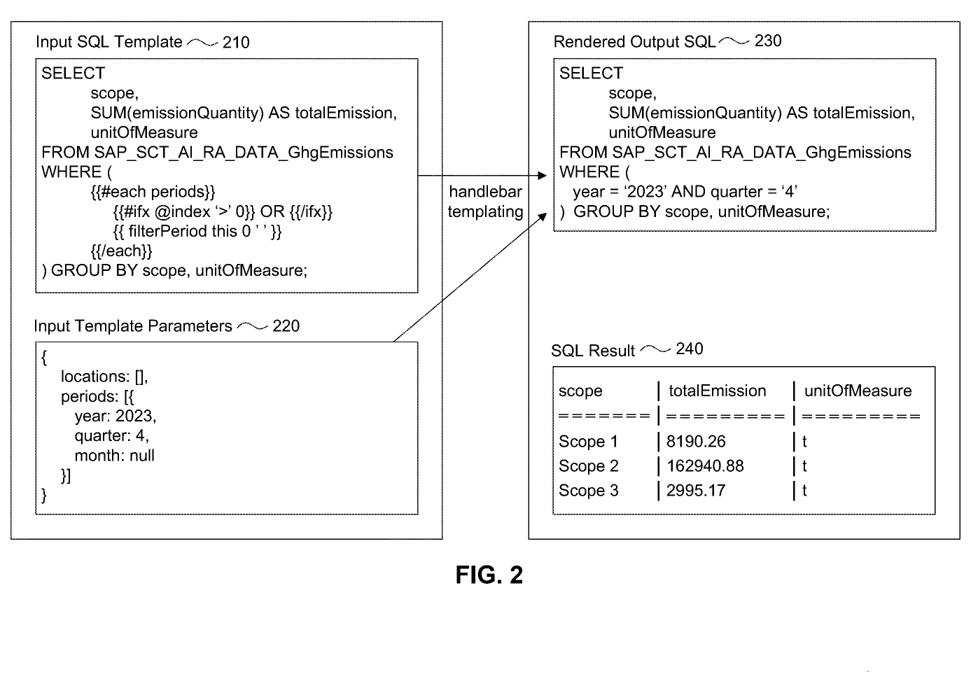

FIG. 2 illustrates example intermediary output which may be generated by a data control and reporting system (DRS) 102, according to some embodiments. Box 210 illustrates an example query template 130 (as illustrated in FIG. 1), box 220 illustrates an example set of query parameters 134 (as illustrated in FIG. 1), box 230 illustrates an example query 136 (as illustrated in FIG. 1), and box 240 illustrates an example query result 138 (with collected data 14) (as illustrated in FIG. 1). In some embodiments, handlebar templating may be used to generate the query 136 or output SQL 230 as illustrated.

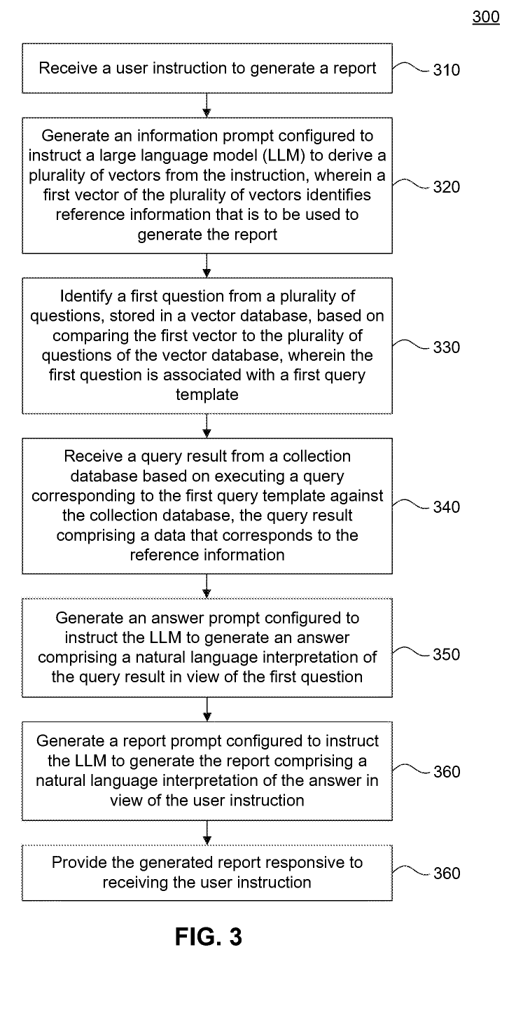

FIG. 3 is a flowchart 300 illustrating example operations for providing a data control and reporting system (DRS) 102, according to some embodiments. Method 300 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 3, as will be understood by a person of ordinary skill in the art. Method 300 shall be described with reference to FIG. 1.

In 310, a user instruction to generate a report is received. For example, DRS 102 may receive a user instruction 110. The user instruction 110 may be a command or request from a user 106 to generate a report 108. In some embodiments, the user instruction 110 may specify different elements such as a timeframe for the report, and a format of the report 108 (e.g., chart, table, graph, text, etc).

In 320, an information prompt configured to instruct a large language model (LLM) to derive a plurality of vectors from the instruction is generated. For example, prompt generator 112 may generate an information prompt 114 for LLM 104. Information prompt 114 may instruct the LLM 104 to derive, identify, or generate one or more vectors 122A, 122B from user instruction 110. The vectors 122 may identify what reference information 120 or data is necessary to generate the report 108 indicated in the user instruction 110.

In 330, a first question from a plurality of questions is identified based on comparing the first vector to the plurality of questions, wherein the first question is associated with a first query template. For example, DRS 102 may identify a first question 124 from a plurality of questions 124 that are stored in a vector database 126 based on comparing a vector 122A to the questions 124 of the vector database 126, or performing some form of similarity search. Each question 124 in vector database 126 may be paired with a corresponding query template 130, which may be used to generate a query 136 to execute against a collection database 128.

In 340, a query result is received from a collection database based on executing the query corresponding to the first query template against the collection database, the query result comprising a data that corresponds to the reference information. For example, DRS 102 may generate a query 136 by replacing the placeholders 132 of the query template 130 with parameters 134 (e.g., data from the vector(s) 122 and/or user instruction 110 specific to the inquiry, command, or request received from the user 106). The query 136 may be executed against the collection database 128, which may return a query result 138. The query result 138 may include collected data 140 that corresponds to the information or data indicated by one or more of the vectors 122.

In 350, an answer prompt configured to instruct the LLM to generate an answer comprising a natural language interpretation of the query result in view of the first question is generated. For example, prompt generator 112 may generate an answer prompt 116 instructing LLM 104 to generate a natural language interpretation of the query result 138 in view of the question 124. The answer prompt 116 may provide both the question 124 and the query result 138 (including the collected data 140), to LLM 104, which may then generate an answer 142.

In 360, a report prompt configured to instruct the LLM to generate the report comprising a natural language interpretation of the answer in view of the user instruction is generated. For example, prompt generator 112 may generate a report prompt 118 instructing LLM 104 to generate a natural language interpretation of the answer 142 in view of the user instruction 110. The report 108 may include charts, graphs, text, images, and/or other media formatted in a way to respond to user instruction 110.

370 the generated report is provided responsive to receiving the user instruction. For example, DRS 102 may return the report 108 to the user 106 in the form of a file, display on a user interface of a device, or other electronic medium.

FIGS. 4A and 4B illustrate example operations for generating different content by a data control and reporting system (DRS) 102, according to some embodiments. In some embodiments, DRS 102 may perform different operations depending on the type of content is to be output or generated (e.g., textual content, or chart/table content). FIG. 4A illustrates example operations relative to generated textual content, and FIG. 4B illustrates example operations relative to generating chart or table content.

In FIG. 4A, at 402, DRS 102 may receive a user instruction 110. At 404, prompt generator 112 may generate the information prompt 114 to instruct LLM 104 to identify what information is required to satisfy the user instruction 110. At 406, the LLM 104 may return reference information 120 including one or more vectors 122.

At 408, DRS 102 may perform a vector search on vector database 126 using each of the vectors 122 received from LLM 104. The vector database 126 may include multiple pairs of questions 124 and corresponding query templates 130. In some embodiments, the questions 124 and query templates 130 may be arranged as key-value pairs in vector database 126. At 410, the vector search may result in returning zero or more questions 124 that match each vector 122 and their corresponding query template 130.

At 412, the placeholders 132 in each query template 130 may be replaced with values of actual corresponding parameters 134 (as retrieved from the vector 122) to generate a query 136. Each query 136 may be executed against collection database 128 to generate a query result 138 including collected data 140 that satisfies the query 136.

At 414, the answer prompt 116 may pair the question 124 with the corresponding query result 138 (for the query 136 generated from the query template 130 for that question 124), and instruct LLM 104 to generate an answer 142. The answer 142 may be a fact that is derived from or based on the actual data retrieved from the collection database 128. In some embodiments, the answer 142 may only be based on the collected data 140 retrieved from collection database 128.

If, for a particular vector 122B, no question 124 was identified or no data from collection database 128 satisfied the corresponding query 136, then the corresponding answer 142 may indicate that the portion of user instruction 110 corresponding to the vector 122B could not be found or satisfied. In some embodiments, this may invalidate the entire user instruction 110, in other embodiments, the remaining portion of user instruction 110 (e.g., as corresponding to other vector(s) 122A) may be processed without the answer 142 for vector 122B, and the portion(s) for which no question 124 was identified the LLM 104 may return with an empty set or negative answer that no relevant data was found.

At 416, prompt generator 112 may generate the report prompt 118 including both the answer(s) 142 and the original user instruction 110, and provide these to the LLM 104 to generate the report at 418. At 420, the report 108 may be generated by LLM 104 and output by DRS 102 or returned to user 106 through electronic communications.

In FIG. 4B, at 450 a user instruction 110 may be received. In some embodiments, DRS 102 may perform initial analysis or processing on user instruction 110 to identify whether the user instruction 110 includes a request for a chart as part of output or report 108. In some embodiments, the user 106 may explicitly request a chart/table by adding through relevant user interface operations.

In some embodiments, prompt generator 112, as part of or in addition to information prompt 114 may instruct LLM 104 to identify the type of data requested by user 106 in user instruction 110. LLM 104 may return the data type(s) identified in user instruction 110, such as text (which may be the default data type if none are specified), chart (e.g., bar, pie, line, etc.), table, or other. If the data type is or includes chart and/or table, the processing in FIG. 4B may be performed in addition to or in lieu of the general, default, or text content generation processing described above with respect to FIG. 4A. For simplicity, chart content generation is described with respect to FIG. 4B, however it is understood that table content generation may be performed in a similar manner.

At 452, DRS 102 my identify a JSON (JavaScript Object Notation) schema related to the chart or type of chart that is identified in user instruction 110. In some embodiments, the JSON schema may be selected from a library or database of JSON schema. In some embodiments, the Chart/Table Parameter Configuration JSON may be programmatically used to generate SQL queries and finally generate chart rendering parameters as described herein.

At 454, DRS 102 may identify the context and metadata relevant to generating the desired or indicated chart or table, as identified from user instruction. The context may include the table and/or particular columns (of collection database 128) relevant to generating the chart. In some embodiments, LLM 104 may provide one or more vectors 122 as described above, and those vector(s) 122 may be used by DRS 102 to identify the relevant table(s) and/or columns from collection database 128 which is provided as context.

In some embodiments, the context may include metadata. The metadata may include descriptors of the context, describing the information or data stored in each table and/or column. For example, a first table may be selected with the metadata that reads “This table includes information about factory emissions”. This metadata information may be beneficial to help LLM 104 understand what data should be used generating the chart.

At 456, prompt generator 112 may generate a prompt, such as answer prompt 116 or report prompt 118, instructing LLM to generate the output (e.g., report 108 or answer 142) of chart parameter configuration in a JSON format. The chart parameter configuration may indicate the type of chart, a mapping between the x-axis and a column, a mapping between y-axis and a column, names for table both axis, etc.

At 458, DRS 102 may use the chart parameter configuration, as output by LLM 104, to generate an SQL query to retrieve or extract the actual data values from the identified columns in the chart configuration file. DRS 102 may also generate or retrieve any charting (or table) library or parameters from a JSON library. At 460, these two inputs may be combined to render the chart in HTML (hyper text markup language) format, in a document (e.g., a word processing file), or other electronic format and medium.

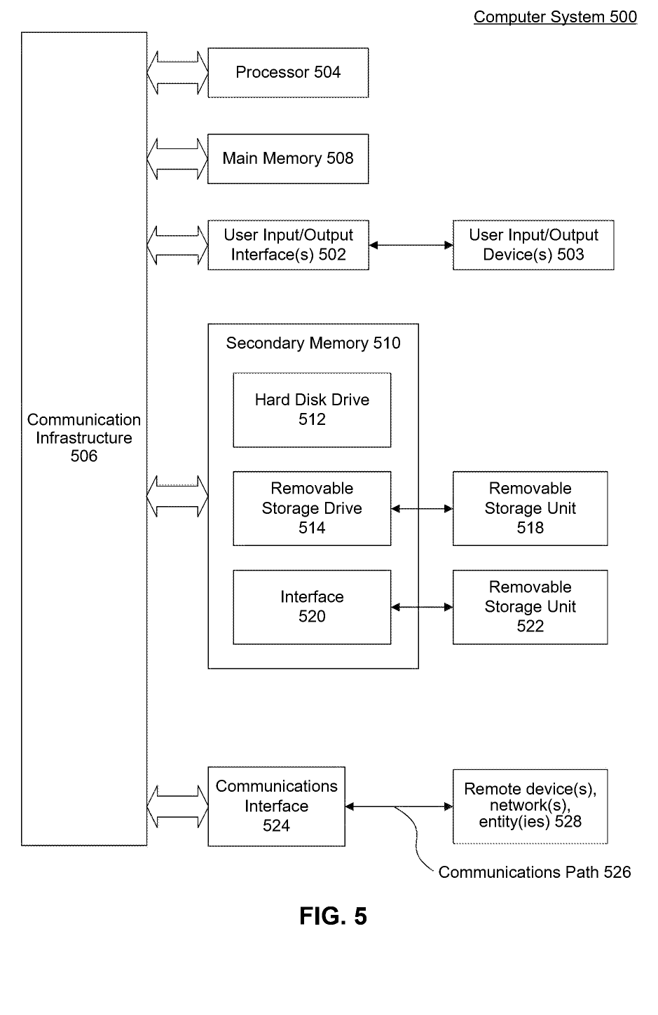

Various embodiments may be implemented, for example, using one or more well-known computer systems, such as computer system 500 shown in FIG. 5. One or more computer systems 500 may be used, for example, to implement any of the embodiments discussed herein, as well as combinations and sub-combinations thereof.

Computer system 500 may include one or more processors (also called central processing units, or CPUs), such as a processor 504. Processor 504 may be connected to a communication infrastructure or bus 506.

Computer system 500 may also include user input/output device(s) 503, such as monitors, keyboards, pointing devices, etc., which may communicate with communication infrastructure 506 through user input/output interface(s) 502.

One or more of processors 504 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 500 may also include a main or primary memory 508, such as random access memory (RAM). Main memory 508 may include one or more levels of cache. Main memory 508 may have stored therein control logic (i.e., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 518. Removable storage unit 518 may include a computer usable or readable storage device having stored thereon computer software (control logic) and/or data. Removable storage unit 518 may be a floppy disk, magnetic tape, compact disk, DVD, optical storage disk, and/ any other computer data storage device. Removable storage drive 514 may read from and/or write to removable storage unit 518.

Secondary memory 510 may include other means, devices, components, instrumentalities or other approaches for allowing computer programs and/or other instructions and/or data to be accessed by computer system 500. Such means, devices, components, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 500 may further include a communication or network interface 524. Communication interface 524 may enable computer system 500 to communicate and interact with any combination of external devices, external networks, external entities, etc. (individually and collectively referenced by reference number 528). For example, communication interface 524 may allow computer system 500 to communicate with external or remote devices 528 over communications path 526, which may be wired and/or wireless (or a combination thereof), and which may include any combination of LANs, WANs, the Internet, etc. Control logic and/or data may be transmitted to and from computer system 500 via communication path 526.

Computer system 500 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 500 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 500 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 5. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method, comprising:
receiving a user instruction to generate a report;
generating an information prompt configured to instruct a large language model (LLM) to derive a plurality of vectors from the user instruction, wherein a first vector of the plurality of vectors identifies reference information that is to be used to generate the report;
identifying a first question from a plurality of questions based on comparing the first vector to the plurality of questions, wherein the first question is associated with a first query template;
receiving a query result from a collection database based on executing a query corresponding to the first query template against the collection database, the query result comprising a data that corresponds to the reference information;
generating an answer prompt configured to instruct the LLM to generate an answer comprising a natural language interpretation of the query result in view of the first question;
generating a report prompt configured to instruct the LLM to generate the report comprising a natural language interpretation of the answer in view of the user instruction; and
providing the generated report responsive to receiving the user instruction.

2. The computer-implemented method of claim 1, further comprising:
identifying a placeholder in the first query template, wherein the first query template is not executable with the placeholder.

3. The computer-implemented method of claim 2, further comprising:
generating the query by replacing the placeholder in the first query template with a parameter, wherein the parameter comprises a portion of the reference information from the first vector, and wherein the query is executable.

4. The computer-implemented method of claim 1, wherein the identifying the first question comprises:
identifying multiple questions, of the plurality of questions, that are associated with the reference information of the first vector, and wherein each of the multiple questions is paired with its own unique query template.

5. The computer-implemented method of claim 4, wherein each unique query template is executed against the collection database, and wherein the query result comprises collected data corresponding to each unique query template.

6. The computer-implemented method of claim 5, wherein the LLM is configured to select a subset of the collected data, and wherein the answer comprises the natural language interpretation of the selected subset of collected data in view of the first question.

7. The computer-implemented method of claim 1, wherein the report comprises a chart.

8. The computer-implemented method of claim 1, further comprising:
generating a reusable template comprising the plurality of vectors, the first question, and the first query template; and
receiving a request for the reusable template to generate a subsequent report.

9. The computer-implemented method of claim 1, wherein the plurality of questions are stored in a vector database.

10. A system comprising:
a memory; and
at least one processor coupled to the memory and configured to perform operations comprising:
receiving a user instruction to generate a report;
generating an information prompt configured to instruct a large language model (LLM) to derive a plurality of vectors from the user instruction, wherein a first vector of the plurality of vectors identifies reference information that is to be used to generate the report;
identifying a first question from a plurality of questions based on comparing the first vector to the plurality of questions, wherein the first question is associated with a first query template;
receiving a query result from a collection database based on executing a query corresponding to the first query template against the collection database, the query result comprising a data that corresponds to the reference information;
generating an answer prompt configured to instruct the LLM to generate an answer comprising a natural language interpretation of the query result in view of the first question;
generating a report prompt configured to instruct the LLM to generate the report comprising a natural language interpretation of the answer in view of the user instruction; and
providing the generated report responsive to receiving the user instruction.

11. The system of claim 10, the operations further comprising:
identifying a placeholder in the first query template, wherein the first query template is not executable with the placeholder.

12. The system of claim 11, the operations further comprising:
generating the query by replacing the placeholder in the first query template with a parameter, wherein the parameter comprises a portion of the reference information from the first vector, and wherein the query is executable.

13. The system of claim 10, wherein the identifying the first question comprises:
identifying multiple questions, of the plurality of questions, that are associated with the reference information of the first vector, and wherein each of the multiple questions is paired with its own unique query template.

14. The system of claim 13, wherein each unique query template is executed against the collection database, and wherein the query result comprises collected data corresponding to each unique query template.

15. The system of claim 14, wherein the LLM is configured to select a subset of the collected data, and wherein the answer comprises the natural language interpretation of the selected subset of collected data in view of the first question.

16. The system of claim 10, wherein the report comprises a chart.

17. The system of claim 10, the operations further comprising:
generating a reusable template comprising the plurality of vectors, the first question, and the first query template; and
receiving a request for the reusable template to generate a subsequent report.

18. The system of claim 10, wherein the plurality of questions are stored in a vector database.

19. A non-transitory computer-readable medium having instructions stored thereon that, when executed by at least one computing device, cause the at least one computing device to perform operations comprising:
receiving a user instruction to generate a report;
generating an information prompt configured to instruct a large language model (LLM) to derive a plurality of vectors from the user instruction, wherein a first vector of the plurality of vectors identifies reference information that is to be used to generate the report;
identifying a first question from a plurality of questions based on comparing the first vector to the plurality of questions, wherein the first question is associated with a first query template;
receiving a query result from a collection database based on executing a query corresponding to the first query template against the collection database, the query result comprising a data that corresponds to the reference information;
generating an answer prompt configured to instruct the LLM to generate an answer comprising a natural language interpretation of the query result in view of the first question;
generating a report prompt configured to instruct the LLM to generate the report comprising a natural language interpretation of the answer in view of the user instruction; and
providing the generated report responsive to receiving the user instruction.

20. The non-transitory computer-readable medium of claim 19, the operations further comprising:
identifying a placeholder in the first query template, wherein the first query template is not executable with the placeholder.
